(19) United States
(12) Patent Application Publication
(10) Pub. No.: US 2007/0045336 A1
(43) Pub. Date: Mar. 1, 2007

(54) Point of purchase stand for displaying and dispensing a plurality of retail articles

(75) Inventors: Myrna Munoz, Col. Alamos (MX); Enrique Ventrua Moreno, Col. Fuentes del Pedregal (MX); Luis Saturno, Col. Condesa (MX)

Correspondence Address: HOFFMANN & BARON, LLP, 6900 JERICHO TURNPIKE, SYOSSET, NY, 11791, US

(73) Assignee: Cadbury Adams USA LLC

(21) Appl. No.: 11/504,978

(22) Filed: Aug. 16, 2006

Related U.S. Application Data
(60) Provisional application No. 60/713,213, filed on Aug. 31, 2005.
(60) Provisional application No. 60/757,975, filed on Jan. 11, 2006.

(51) Int. Cl. G07F 11/16

(52) U.S. Cl. 221/226

(57) ABSTRACT

A device provides for the displaying and dispensing of a plurality of retail articles from a point of purchase stand. The device includes a housing having a plurality of faces. A plurality of elongate vertically oriented dispensing magazines are aligned with the faces of the housing. Each magazine supports a plurality of articles in at least one vertically stacked array. Each magazine further includes a dispensing opening at the lower end thereof and an article retaining element for removably supporting one of the articles at the dispensing opening. A display window covers the faces of the housing. The display window retaining the array of articles in the magazine and being transparent for permitting viewing of the articles.

### CROSS-REFERENCE TO RELATED APPLICATIONS

This application claims priority to U.S. Provisional Application No. 60/713,213, filed Aug. 31, 2005, and U.S. Provisional Application No. 60/757,975, filed Jan. 11, 2006, which are incorporated herein by reference.

### FIELD OF THE INVENTION

The present invention relates generally to a point of purchase stand which displays and dispenses retail articles. More particularly, the present invention relates to a rotating stand having provisions for accommodating a plurality of different retail articles, such as packages, which may contain confectionary products such as gum in the form of slabs, sticks, pellets or the like and which is rotatable to display and dispense the packages.

### BACKGROUND OF THE INVENTION

The art has seen a wide variety of devices used to contain, dispense and display various articles of merchandise. Specifically, the art has seen a variety of devices used to display and dispense confectionary products such as candy and gum which may be located at the point of purchase typically adjacent the cash register at a retail store. Many of the display devices used at the point of purchase are designed to accommodate a single product. Such display device is thereby dedicated to that product and may include advertising information related to the single product.

Other display devices are designed to contain and dispense a plurality of different products. These display devices may include plural compartments to store the different products. These display devices are usually cumbersome and difficult to use. Multi-compartment display devices are shown, for example, in U.S. Pat. No. 6,189,710 and U.S. Pat. No. 5,255,801.

Still other display devices are suitable for both retaining and dispensing an array of products.

U.S. Pat. No. 5,370,220 shows such a display device. However, the products themselves are hidden from view. This tends to detract from the advertising potential of the display device. Moreover, additional advertising and informational indicia must be placed on this display device. This results in the display device being dedicated to one type of product.

There is a need therefore for a display and dispensing device which may be easily loaded and display in an attractive and informative manner a variety of products in the display device.

### SUMMARY OF THE INVENTION

The present invention provides a device for displaying and dispensing retail articles. The device includes a housing having a plurality of faces. A plurality of elongate vertically oriented dispensing magazines are aligned with each of the faces of the housing. Each magazine supports a plurality of articles in at least one vertically stacked array. Each magazine further includes a dispensing opening at the lower end thereof and an article retaining element. The retail article is removably supported by the article retaining element for dispensing at the dispensing opening. A display window covers the faces of the housing so as further retain the array of articles in the magazine. The display window is transparent permitting viewing of the articles and the indicia contained thereon.

In a preferred embodiment of the present invention, each of the faces of the display device may be designed to accommodate a different array of products.

Furthermore, the housing further includes a rotatable base wherein the housing is rotatable with the base.

In a method aspect, the present invention provides a method of merchandising retail articles. The method includes providing a display and dispensing housing having a plurality of faces. Each of the faces includes at least one vertically oriented display and dispensing magazine. Each magazine includes a dispensing opening and a display window. A plurality of first type retail articles are loaded into the magazine such that the articles are visible through the display window. A plurality of second type retail articles are loaded into another of said magazines such that the articles are visible through the display window thereof. Each of the first and second retail articles include distinct indicia thereon which is visible through the display window.

### BRIEF DESCRIPTION OF THE DRAWINGS

FIG. 1 is a perspective showing of the display and dispensing device of the present invention.

FIG. 2 is a front plan view of the display device of FIG. 1.

FIG. 3 is a side plan view of the display device of FIG. 1.

FIG. 4 is a top plan view of the display device of FIG. 1.

FIG. 5 shows a display and dispensing device of FIG. 1 including a plurality of articles being accommodated therein.

FIG. 6 shows the device of FIG. 1 with the articles fully loaded into the device.

FIG. 7 shows the device of FIG. 1 depicting the dispensing of one article.

### DETAILED DESCRIPTION OF THE PREFERRED EMBODIMENT

The present invention provides a point of purchase stand for displaying and dispensing a plurality of retail articles. The stand may be used in a retail establishment at the point of purchase such as the cash register. Such placement places the stand at the checkout area to facilitate impulse purchases. The present invention allows the articles contained within the stand to serve as the advertising medium as the articles may be viewed while arranged in the stand. Moreover, the stand allows a plurality of different type articles to be displayed and dispensed in a single structure.

In the present illustrative embodiment, the display and dispensing stand may be used to support a plurality of packages which contain confectionary products such as gum which may take the form of pellets and slabs or the like. Moreover, the display and dispensing stand of the present invention may be used to house two different configurations of packages such as a blister package which supports gum pellets and a gum package which supports gum slabs. The display and dispensing stand of the present invention allows the purchaser to distinguish and select between the different configurations of packages supported in the stand.

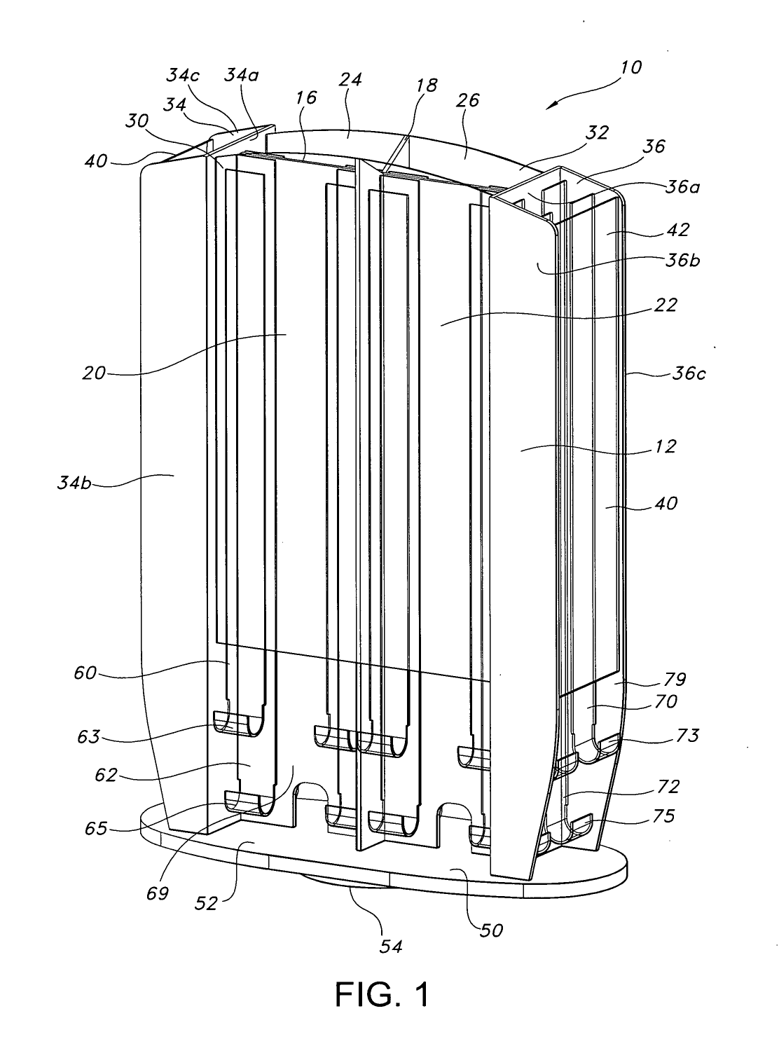

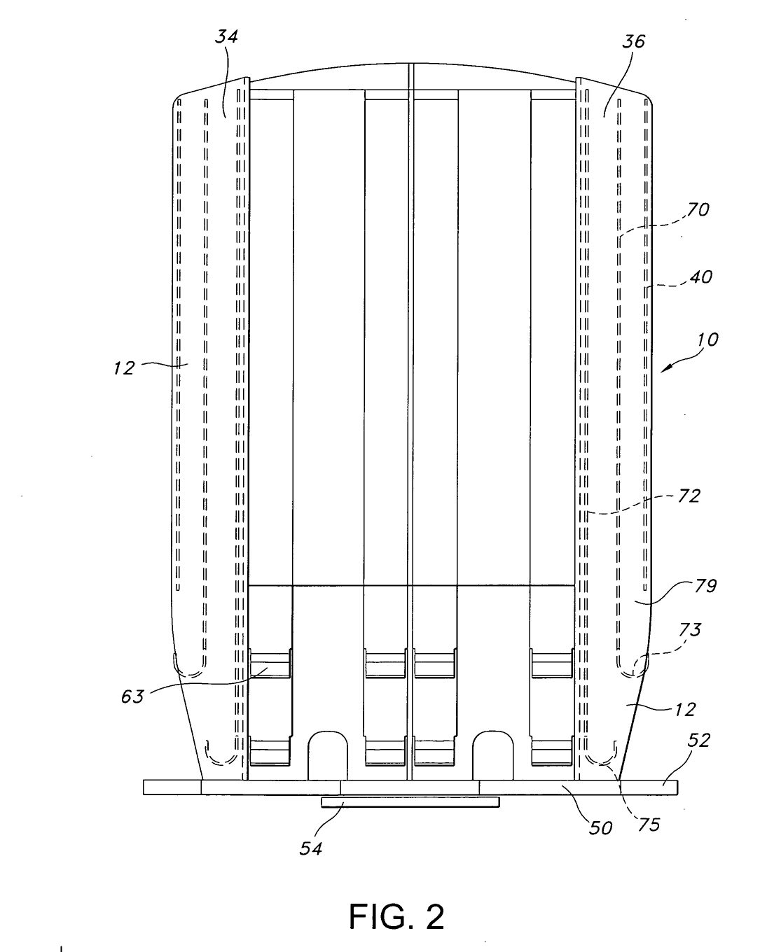

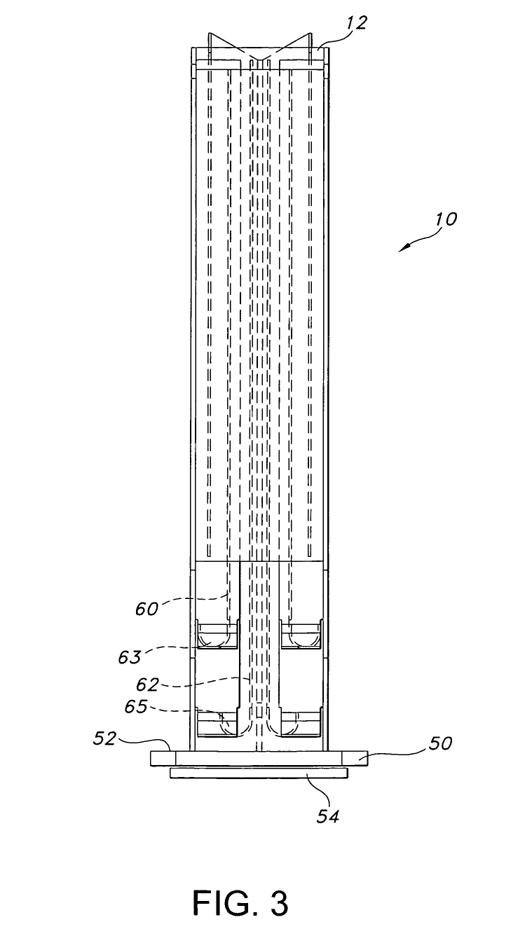

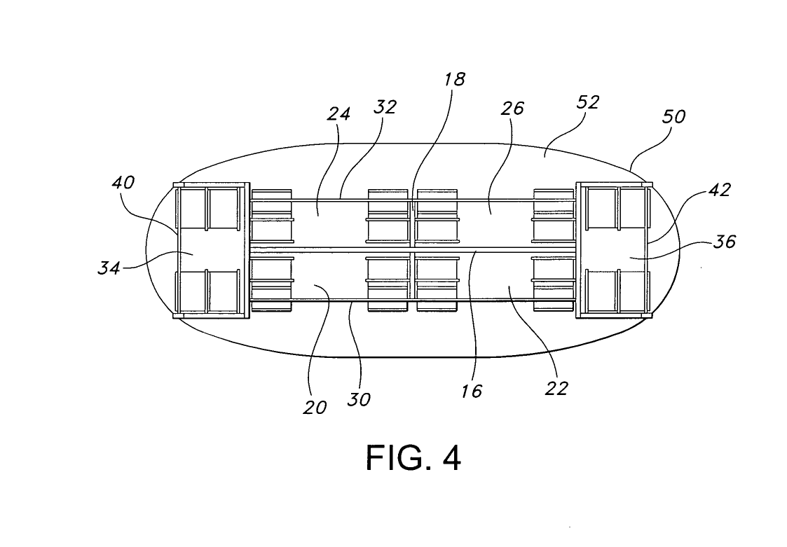

Referring now to FIGS. 1-4, the display and dispensing stand 10 of the present invention is shown. Stand 10 includes an article containing and dispensing housing 12. The housing 12 is generally an upstanding rectangular member defined by an elongate central wall 16 and a transverse dividing wall 18. Walls 16 and 18 divide housing 10 into four side-by-side and front-to-back compartments or magazines 20, 22, 24 and 26. Magazines 20 and 22 are bounded at a front face by a window 30 extending thereacross while magazines 24 and 26 are also bounded by a window 32 extending thereacross.

Housing 10 further includes a pair of oppositely directed elongate compartments or magazines 34 and 36 on either side thereof. Magazines 34 and 36 are bounded by back walls 34a, 36a and side walls 34b, 34c and 36b, 36c. The faces of magazine 34 and 36 may be bounded by display windows 40 and 42. Each of the magazines 20, 22, 24, 26, 34 and 36 are open ended for insertable receipt of a plurality of retail articles, which as will be described in further detail hereinbelow are arranged in a vertically stacked array therein.

Housing 12 is supported on the base 50. Base 50 includes a planar platform 52 on which housing 12 sits. Base 50 further includes an extending central foot 54 about which planar platform 52 rotates. Such rotation allows the housing 12 to be rotatable with base 50 providing access to all six faces thereof to the consumer.

Display stand 10 including housing 12 and base 50 may be formed of a wide variety of materials. In the present illustrative embodiment, housing 10 is formed of molded plastic and may be brightly colored for attractiveness. The windows 30 and 32 are formed of transparent plastic to allow clear viewing of the packages supported therein. While not shown, portions of the stand 10, such as the base 50, may include logos or other indicia thereon.

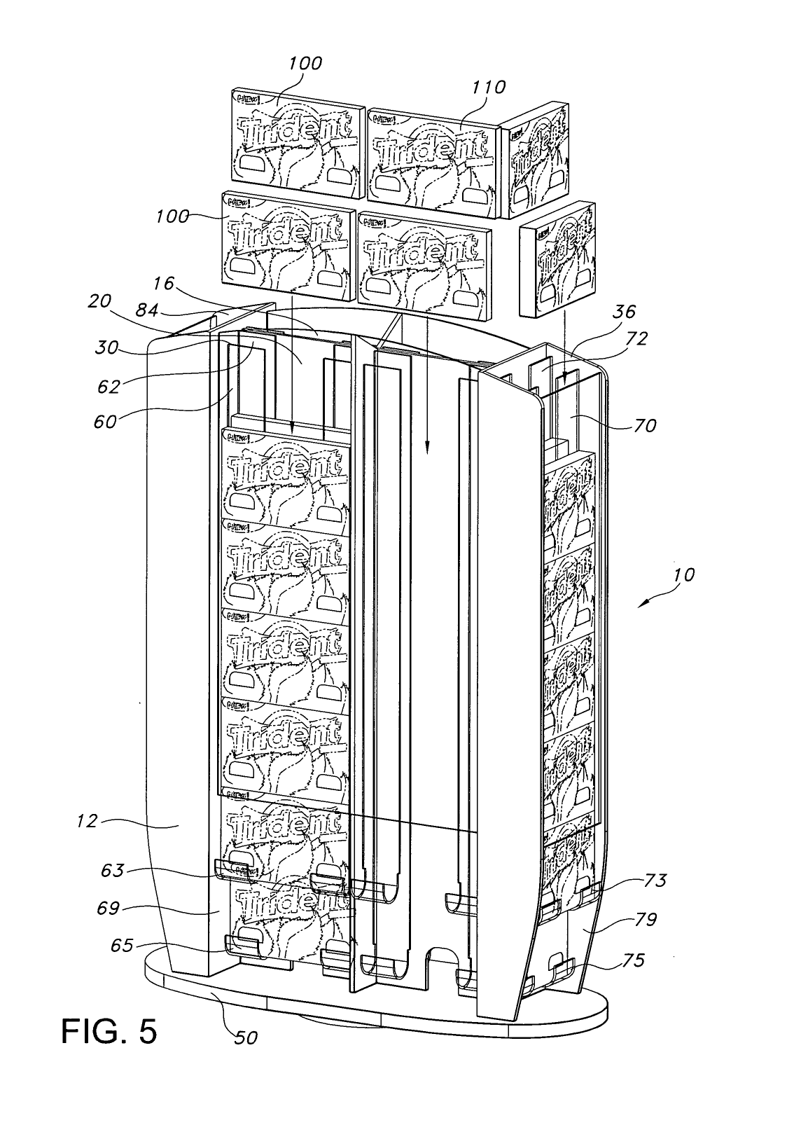

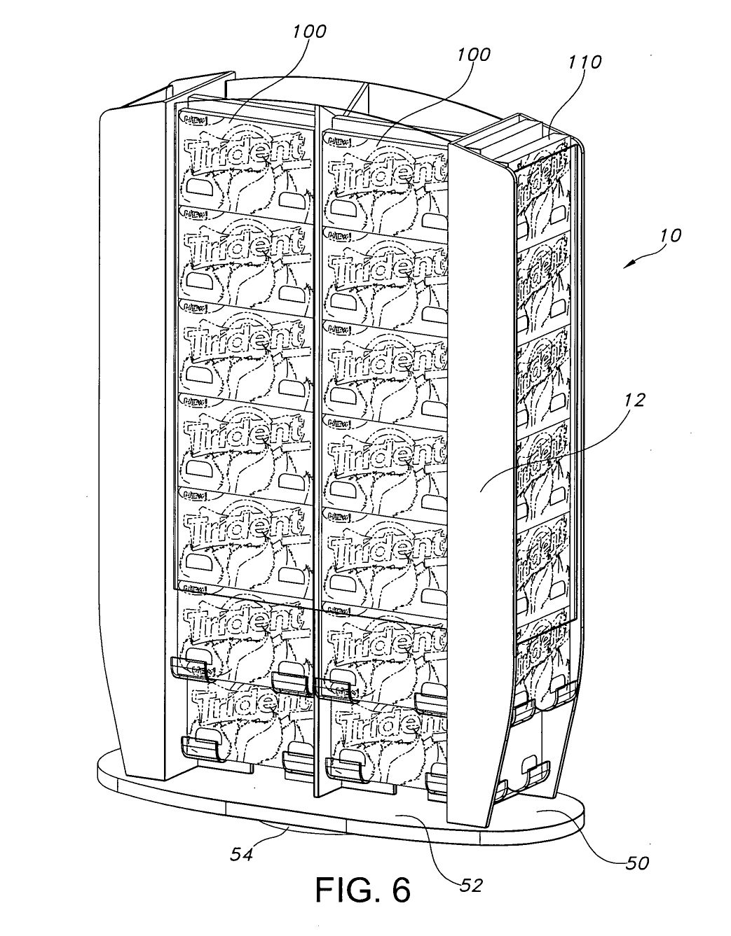

Referring additionally to FIGS. 5-7, the stand 10 is designed to accommodate a plurality of gum-containing packages, of different types (such as flavors) and of different configurations (such as blister packages and slab packages). In the present illustrative embodiment, each magazine 20, 22, 24, 26, 34 and 36 accommodates two columns of gum packages in vertically stacked arrays in a front to back relationship for display and dispensing.

Referring now to magazine 20, which is identical to magazine 22, 24, and 26, two columns of blister packages 100 are supported between wall 16 and window 30 in front to back orientation. In order to accommodate the two columns of blister packages 100, magazine 20 includes therein two pair of elongate guide rails 60 and 62. Guide rails 60, which are the front guide rails, are spaced apart and extend longitudinally along magazine 20. The lower end of each guide rail 60 includes a J-shaped catch or hook 63. As shown in FIG. 5, the J-shaped hook serves as a retaining element to support and hold the lower blister package 100 of the column which is loaded into magazine 30. Additional blister packages 100 may be loaded along guide rails 60 to support a front column of blister packages 100 in a vertically stacked array within magazine 20 as shown in FIGS. 5-7.

In a similar fashion, rear guide rails 62 support a second column of blister packages 100 behind the first column. Each rear guide rail 62 also includes a J-shaped hook 65 at the lower ends thereof serving as a retaining element for supporting and holding one blister package 100 thereat. Additional blister packages may be supported thereover in a vertically stacked array.

Window 30, which extends over magazine 20, terminates short of base 50 so as to provide a dispensing opening 69 at the lower end thereof. The dispensing opening 69 allows access to both the front column of blister packages as well as the rear column packages of blister packages. In this regard, rear guide rails 62 extend to a location adjacent planar portion 52 of base 50 while the front guide rails 60 extend to a location spaced thereabove. Such an arrangement allows simultaneous access to both the rear column and the front column dispensing opening 69.

As may be appreciated, the remaining magazines 22, 24 and 26 are identically constructed so as to each magazine supports a pair of columns of blister packages.

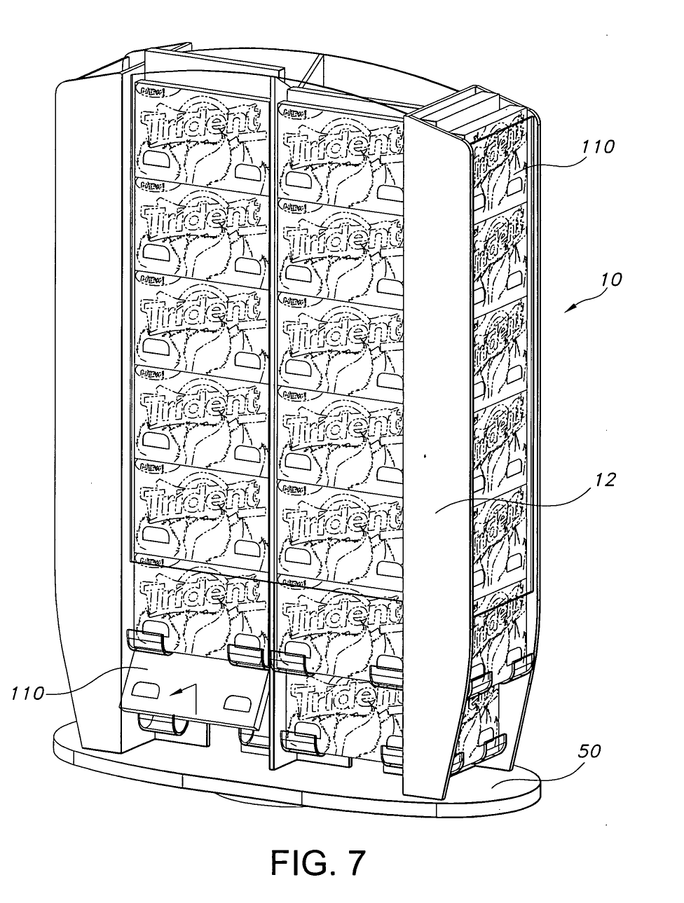

As the windows 30 and 32 covering the magazines are transparent, the indicia contained on the blister packages serves as advertising to help merchandize the product. Such an arrangement allows different type of blister packages (such as blister packages having different indicia indicating different flavors) to be loaded into the different magazines. The purchaser may dispense from the lower opening 69 the desired flavor of gum from the selected magazine by lifting the lower package up off of the J-shaped hooks in a manner shown in FIG. 7. As may be appreciated, the array of packages then drop down making the next package accessible.

The stand of the present invention also provides for displaying and dispensing different types of packages. Magazines 30 and 34 may be employed to support two columns of gum packages which differ from the blister package 100. In the present illustrative embodiment, the gum packages 110 are gum packages which contain gum slabs and are of a different shape and configuration from those of the blister packages described above.

Magazines 34 and 36 are identical and, therefore, the description will made with respect to magazine 36. Magazine 36 includes two pairs of guide rails 70 and 72 which support two columns of gum packages in a manner described above. Front rails 70 which support one column of gum packages each including a J-shaped hook 73 at the lower end thereof which define a retaining element for supporting the lower package 110 of the front column thereat. In a similar manner, the rear rails 72 include at the lower end thereof a J-shaped hook 75 for similarly supporting the lower package 110 of the rear column. Window 40 terminates to a location spaced above planar portion 52 of base 50 to provide a dispensing opening 79 so as to permit similar removal of the lower package from each of the front and back columns. In that regard, the rear rails 72 extend to location adjacent planar portion 52 of base 50 while the front rails 70 extend to a location spaced thereabove to permit access to both columns of packages. Transparent windows 40 and 42 allow the advertising indicia contained on the package to be displayed therethrough thereby allowing the consumer to view and make the appropriate selection from the respective magazine.

Each magazine 34 and 36 may contain a different type of package (different flavor of gum) providing selectivity for the consumer.

It thus may be appreciated that the display and dispensing stand of the present invention provides the ability to dispense various different configurations of gum packages and various different types of gums (flavors) of the same configuration of package. Moreover, the transparent windows of the display device of the present invention allow the package advertising to serve as the dispenser advertising thereby obviating the need for additional advertising on the display stand and thereby allowing the display stand to be used universally with different types of packages.

What is claimed is:

1. A device for displaying and dispensing retail articles comprising:
a housing having a plurality of faces;
a plurality of elongate vertically oriented dispensing magazines aligned with said faces of said housing, each magazine supporting a plurality of articles in at least one of vertically stacked array, each magazine further having a dispensing opening at the lower end thereof and an article retaining element for removably supporting one of said articles at said dispensing opening; and
a display window covering said faces of said housing said display window retaining said array of articles in said magazine and being transparent for permitting viewing of said articles.

2. A device of claim 1 wherein said magazines are of different configurations for accommodating different said plurality of articles.

3. A device of claim 1 wherein each of said magazines accommodate said articles in plural front-to-back rows.

4. A device of claim 1 wherein said article retaining element includes at least one hook shaped catch.

5. A device of claim 1 further including a base, said base supporting said housing in an upright orientation.

6. A device of claim 5 wherein said base is rotatable and said housing is attached to said base for rotation therewith.

7. In combination, a display and dispensing device and a plurality of different retail articles supported by said device comprising:
a housing having a plurality of faces; and
a plurality of elongate vertically oriented horizontally spaced magazines, each magazine supporting a plurality of said retail articles of one type, wherein said retail article of one magazine are of a different type from said retail articles of another said magazine;
each said magazine having a dispensing opening at a lower end wherein said retail articles are capable of being dispensed one-at-a time;
each magazine being covered by a display window which covers the faces of the housing an is transparent for allowing viewing of said plurality of articles of said different type.

8. A combination of claim 7 wherein said magazine opening is gravity fed.

9. A combination of claim 8 wherein said magazines are of different configurations for accommodating said different types of said articles.

10. A combination of claim 8 wherein each said magazine includes an article retaining element for retaining one of said articles at said magazine opening.

11. A combination of claim 10 wherein said article retaining element is a hook shaped catch.

12. A combination of claim 7 further including a rotatable base and wherein said housing is rotatably supported on said base for rotation therewith.

13. A combination of claim 9 wherein a first magazine supports a plurality of a first type gum-containing blister packages having a first unique indicia thereon which is visible through said window.

14. A combination of claim 13 wherein a second magazine supports a plurality of said first type gum-containing blister packages having a second unique indicia thereon which is visible through said window.

15. A combination of claim 14 wherein a third magazine supports a plurality of a second type of gum-containing packages which are visible through said window.

16. A method of merchandizing retail articles comprising:
providing a display and dispending housing having a plurality of faces and at least one vertically oriented display and dispensing magazine on each of said faces, each said magazine having a dispensing opening and a display window;
loading a first type of retail article in one of the magazines such that the articles are visible though said display window thereof; and
loading a second type of retail articles in another of said magazine such that the articles are visible through said display window thereof.

17. A method of merchandizing retail articles wherein said first and second retail articles have distinct indicia thereon which is visible through said display windows.
